(19) United States
(12) Patent Application Publication
(10) Pub. No.: US 2026/0180989 A1
(43) Pub. Date: Jun. 25, 2026

(54) SYSTEMS AND METHODS FOR DETECTING DUPLICATE SERIAL NUMBERS IN PASSIVE OPTICAL NETWORKS

(71) Applicant: VERIZON PATENT AND LICENSING INC., Basking Ridge, NJ (US)

(72) Inventors: Denis A. KHOTIMSKY, Westborough, MA (US); David J. BAKER, Mechanicsville, VA (US); Gregory K. SHERRILL, Herndon, VA (US)

(73) Assignee: VERIZON PATENT AND LICENSING INC., Basking Ridge, NJ (US)

(21) Appl. No.: 18/986,918

(22) Filed: Dec. 19, 2024

(51) Int. Cl. H04L 9/40; H04Q 11/00

(52) U.S. Cl. CPC H04L 63/101; H04L 63/102; H04Q 11/0067; H04Q 2011/0064; H04Q 2011/0079; H04Q 2011/0086

(57) ABSTRACT

In some implementations, the techniques described herein relate to a method including: receiving, at an optical line terminal (OLT), a registration request from an optical network unit (ONU); computing an activation fingerprint based on timing values captured during activation of the ONU; receiving an activation digest computed using the activation fingerprint and a privately maintained digest key; storing the activation digest; receiving, during a subsequent activation attempt, the digest key used to compute the stored activation digest; and determining whether the ONU is authorized by comparing the stored activation digest with a verification digest computed using the stored activation fingerprint and the received digest key.

### BACKGROUND

Passive optical networks (PONs) represent a critical infrastructure in modern telecommunications, implementing point-to-multipoint optical fiber topology through an optical distribution network (ODN). An ODN utilizes fiber and passive components, including splitters and combiners, to establish connectivity between central nodes, known as Optical Line Termination (OLT) units, and user nodes, known as Optical Network Units (ONUs). In some PON system embodiments, a single OLT unit is connected to an ODN, and all ONUs use a fixed pair of upstream and downstream wavelength channels associated with said OLT unit. In other PON system embodiments, multiple OLT units are connected to an ODN, each said OLT unit operating on its own unique pair of upstream and downstream wavelength channels, and ONUs can tune to one specific wavelength channel pair at a time.

### BRIEF DESCRIPTION OF THE FIGURES

FIG. 1 is a block diagram illustrating an exemplary passive optical network according to some of the disclosed embodiments.

FIG. 2 is a sequence diagram illustrating an ONU activation process between an OLT and an ONU in a PON according to some of the disclosed embodiments.

FIG. 3 is a sequence diagram illustrating a method for detecting duplicate ONU serial numbers using activation history.

FIG. 4 is a sequence diagram illustrating an alternative method for detecting duplicate ONU serial numbers using activation history.

FIG. 5 is a sequence diagram illustrating a method for detecting duplicate ONU serial numbers during re-activation of an ONU according to some of the disclosed embodiments.

FIG. 6 is a block diagram illustrating a computing device according to some of the disclosed embodiments.

### DETAILED DESCRIPTION

As PON-based networks become increasingly prevalent as an access technology, network operators face growing security challenges related to device authentication and network integrity. Of particular concern is the accurate identification and authentication of ONUs connecting to the network. Current systems rely on unique (e.g., globally unique) identifiers known as ONU serial numbers, which often combine vendor identification and device-specific serial numbers. However, whether through accidental assignment, malicious intent, or sophisticated cloning techniques, these theoretically unique identifiers can be duplicated, leading to potential security vulnerabilities and service disruption.

Each ONU in a PON system comprises a communication hardware device executing specialized software that supports both a network-facing ODN interface and various local-network interfaces, such as wired Ethernet or wireless Wi-Fi interfaces. As PONs have become increasingly prevalent as an access technology, security considerations specific to the PON operating environment have gained significant attention from operators worldwide.

In some PON systems, ONU identification relies on a globally unique ONU serial number assigned to each ONU. By convention, this serial number is defined as a tuple comprising an ONU vendor identifier and a vendor-specific serial number (VSSN). As one example, the ONU vendor identifier may comprise a four-byte field containing four alpha-numeric characters uniquely identifying an ONU vendor, while the VSSN may comprise a four-byte unsigned integer selected by the ONU vendor to uniquely identify a particular ONU among all ONUs manufactured by that vendor.

Network operators may rely on the ONU serial number as a primary service authenticator, sometimes supplementing it with additional authentication steps based on shared secrets between the OLT and ONU. However, operators increasingly face situations where multiple ONUs within the same PON system or across different PON systems declare identical ONU serial numbers. Such duplication can result in service theft when occurring across multiple PONs or cause rogue interference when present on the same PON fiber.

ONU serial number duplication may occur accidentally, through manufacturer oversight or negligence in vendor ID usage or VSSN assignment. Alternatively, it may result from intentional or malicious actions, where actors deliberately reprogram legitimate ONUs or construct fake ONUs to declare non-unique ONU serial numbers. Malicious duplication can be either adversarial, targeting legitimate ONUs or networks without user knowledge, or cooperative, involving coordination with legitimate users or corrupted network operator agents.

Cooperative malicious duplication represents a particularly sophisticated threat to PON security. In such scenarios, a malicious actor may obtain assistance from legitimate network users or from individuals with privileged access to network operations. When network operator agents are compromised, attackers can potentially gain access to network-specific authentication parameters, shared secrets, timing configurations, and other sensitive operational data. This insider knowledge enables the creation of duplicate ONUs that can more effectively mimic legitimate devices, as they can be programmed with valid authentication credentials and accurate timing parameters. The involvement of legitimate users further complicates detection, as the duplicate ONU may operate from a valid service location and exhibit usage patterns consistent with normal subscriber behavior.

Conventional duplicate ONU serial number detection typically involves collecting identifying data elements upon activation through the ONU Management Control Interface (OMCI), such as ONU model, manufacturer serial number, manufacturing date, and hardware version, and reconfirming these data elements on subsequent activations of an ONU with identical serial number While this approach may partially address accidental duplication, it proves ineffective against sophisticated ONU cloning techniques. Enhanced authentication methods specified in PON standards, including OMCI-based secure mutual authentication and IEEE 802.1x-based authentication, can mitigate accidental and adversarial duplication but remain largely ineffective against cooperative duplication.

Overall, the limitations of current authentication methods stem from their reliance on static credentials and identifiers. OMCI-based secure mutual authentication typically employs pre-shared keys or certificates that, once compromised, can be duplicated across multiple devices. Similarly, IEEE 802.1x-based authentication, while providing strong security for traditional networks, faces unique challenges in the PON environment due to the shared nature of the optical medium and the possibility of intercepting authentication exchanges. Moreover, these authentication methods operate at higher protocol layers, making them unable to detect sophisticated physical layer duplication techniques. Even when multiple authentication methods are combined, they fundamentally cannot detect duplication scenarios where all static credentials and identifiers have been successfully copied to a duplicate device.

Notably, fundamental limitations exist in duplicate ONU serial number detection, rooted in PON access network architecture. No protocol-based technique can detect unauthorized ONU transfers between locations on a PON tree when drop fiber lengths are sufficiently similar. Moreover, exact ONU clones maintaining synchronized internal states while alternating transmission become effectively indistinguishable from a single relocated ONU, presenting an inherent limitation in protocol-based detection methods.

The limitation regarding physical ONU movement within a PON network stems from fundamental properties of the time division multiple access (TDMA) system used in PON upstream transmission. The OLT calculates an equalization delay for each ONU based on its round-trip transmission time, ensuring synchronized arrival of upstream transmissions from all ONUs. When an ONU is physically relocated to a new position with a similar fiber length (within approximately one meter, corresponding to about approximately five nanoseconds of transmission time), the change in propagation delay falls within the normal timing variation tolerances of the PON system. Consequently, the OLT cannot distinguish between legitimate ONU relocation and the presence of a duplicate ONU at a similarly distant location. This physical constraint establishes a fundamental bound on the capabilities of any protocol-based duplicate detection system, regardless of its sophistication.

While conventional methods for detecting duplicate ONU serial numbers can effectively identify accidental duplication, they are largely ineffective against sophisticated malicious attacks, particularly those involving static cloning of ONUs. This security challenge arises because static cloning can replicate not just the serial number, but all static identification elements that conventional detection methods rely upon. This creates a significant vulnerability in PON networks that requires a new approach to ensure network security.

The following description describes systems and methods for addressing these shortcomings in current PON systems.

In some implementations, the system can detect duplicate ONU serial numbers through an activation-based authentication process. When an OLT receives an initial registration request from an ONU (e.g., sent when the ONU powers on), it computes and stores an activation fingerprint for the ONU using timing values captured during the activation sequence. The ONU likewise generates the activation fingerprint using the same values. The ONU computes an activation digest using this fingerprint and a privately maintained digest key, which it sends to the OLT. The OLT stores this digest for future reference. During subsequent activation attempts, the ONU provides its previous digest key, allowing the OLT to compute a verification digest using the stored fingerprint. The OLT can then authorize the ONU by comparing this verification digest with the stored activation digest.

To enhance security, the system may implement a seed-based variation. Here, the OLT generates and transmits a random seed value to the ONU before receiving the activation digest. The ONU then incorporates this seed value alongside the activation fingerprint and digest key when computing the activation digest.

The activation fingerprint itself typically combines specific timing markers captured during the activation sequence. As described more fully below, these may include the Superframe Counter (SFC) values from both the ONU-ID assignment and equalization delay assignment messages, along with the assigned ONU-ID and significant digits of the equalization delay values. Since these values are known to both the ONU and OLT, each can independently derive the fingerprint without needing to communicate it over the network.

The system includes mechanisms to handle authentication failures gracefully. When detecting a mismatch between verification and stored digests, it first determines if this results from non-volatile memory loss in the ONU. If confirmed, it initiates an appropriate recovery procedure.

The authorization process also considers memory management aspects. Since the ONU maintains its digest key in non-volatile memory, the system examines activation response patterns for memory reset indicators. This includes checking for default configuration values, verifying initialization values in management fields, and confirming the continuity of device-specific parameters stored in separate memory regions.

While the method can theoretically be defeated by two malicious ONUs maintaining continuous instantaneous synchronization of their internal states and communication patterns, implementing such an attack would require an ultra-low-latency communication channel between the ONUs and precise coordination of their operations. The technical complexity and cost of maintaining such synchronization would typically exceed any potential benefits an attacker might gain, making this theoretical vulnerability impractical to exploit in real-world scenarios.

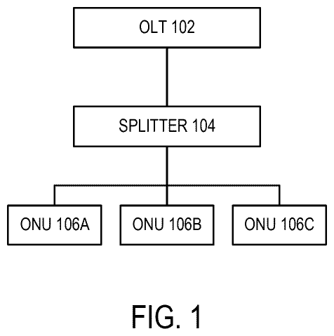

FIG. 1 is a block diagram illustrating an exemplary Passive Optical Network according to some of the disclosed embodiments.

Referring now to FIG. 1, an exemplary PON architecture is shown, illustrating the environment in which the devices, systems, and methods of the disclosure operate. The PON architecture includes an OLT 102 connected via optical fiber to a passive optical splitter 104, which in turn connects to multiple ONUs (ONU 106A, ONU 106B, and ONU 106C). The specific number and location of components depicted in FIG. 1 is not limiting and more or fewer components fall within the scope of the disclosure.

The OLT 102 can serve as the central office terminal and network controller, managing both downstream transmission to the ONUs and upstream transmission from the ONUs. The OLT 102 typically includes specialized hardware and software components designed to handle PON-specific protocols, timing mechanisms, and bandwidth allocation algorithms. In operation, the OLT 102 can maintain precise timing control over the network to ensure proper coordination of transmissions from multiple ONUs.

One characteristic of the PON architecture is its use of passive optical components, represented by (as one example) the optical splitter 104. In some implementations, the splitter 104 can operate without any power supply or active electronics, simply dividing optical signals through physical properties of the splitting element. In downstream transmission (i.e., from OLT to ONUs), the splitter 104 can divide the optical signal from the OLT into multiple paths, each carrying an identical copy of the transmitted data. In upstream transmission (i.e., from ONUs to OLT), the splitter 104 can combine optical signals from multiple ONUs into a single fiber leading to the OLT.

The ONUs (ONU 106A, ONU 106B, and ONU 106C) may be installed as customer premises equipment (CPE) in the PON architecture. In some implementations, each ONU can include hardware and software components to communicate with the OLT, process received signals, and provide various services to end users. ONUs typically support multiple local-facing interfaces, such as wired Ethernet ports, telephony connections, or other service-specific interfaces. While FIG. 1 shows three ONUs for illustrative purposes, a typical PON deployment may support 32, 64, or even 128 ONUs connected to a single OLT port through one or more splitters.

The physical topology created by this arrangement forms a point-to-multipoint network, often described as a tree structure. The trunk of the tree extends from the OLT 102 to the splitter 104, while individual branches extend from the splitter to each ONU. This topology creates two distinct transmission domains: the downstream domain and the upstream domain, each with unique characteristics and challenges.

In the downstream domain, the PON operates as a broadcast medium. When the OLT 102 transmits data, the optical splitter 104 can distribute identical copies of the transmission to all connected ONUs. This means that each ONU receives all downstream transmissions, regardless of the intended recipient. Security in downstream transmission is typically maintained through encryption, allowing each ONU to process only the data intended for it while discarding transmissions intended for other ONUs.

The upstream domain operates differently, employing a multiple access scheme where ONUs share the available transmission capacity of a single wavelength. Since all ONUs transmit toward the OLT through the same optical infrastructure using the same wavelength, coordination is required to prevent transmission conflicts. This coordination is managed by the OLT through various control messages and timing mechanisms, ensuring that the OLT receives the signal from only one ONU at any given time.

The shared nature of both transmission domains creates security considerations unique to PON implementations. In the downstream direction, the broadcast nature of transmission means that malicious actors could potentially intercept transmissions. While user data can be protected through encryption, Operation and Maintenance (OAM) communications, including the entire ONU activation process, are necessarily unencrypted and observable to any party with access to the optical distribution network. In the upstream direction, while observing OAM traffic requires deliberate malicious effort, such observation may be practically undetectable.

Generally, each ONU in the network should be uniquely identifiable to enable proper addressing and access control. In existing networks, this identification is primarily achieved through the ONU serial number, which consists of a vendor identifier and a vendor-specific serial number. The ONU serial number can be used during initial ONU activation, regular operation, and various management functions.

The optical distribution network between the OLT and ONUs can span significant distances, typically up to 20 kilometers. This distance, combined with the varying physical locations of different ONUs, creates differences in signal propagation time between the OLT and each ONU. PON protocols include mechanisms to measure and compensate for these differences, ensuring synchronized operation of the network despite the varying fiber distances.

The architecture illustrated in FIG. 1 represents a single PON interface of what may be a larger access network. In practical deployments, an OLT typically supports multiple PON interfaces, each connected to its own set of ONUs through separate splitters.

While a PON architecture provides the foundation for high-speed optical access networks while minimizing the need for active components in the field, the shared nature of the optical medium, combined with the complexity of managing multiple ONUs, creates unique challenges for network security and access control. The methods and systems described herein address these challenges, particularly in the context of detecting and managing duplicate ONU serial numbers within this architecture.

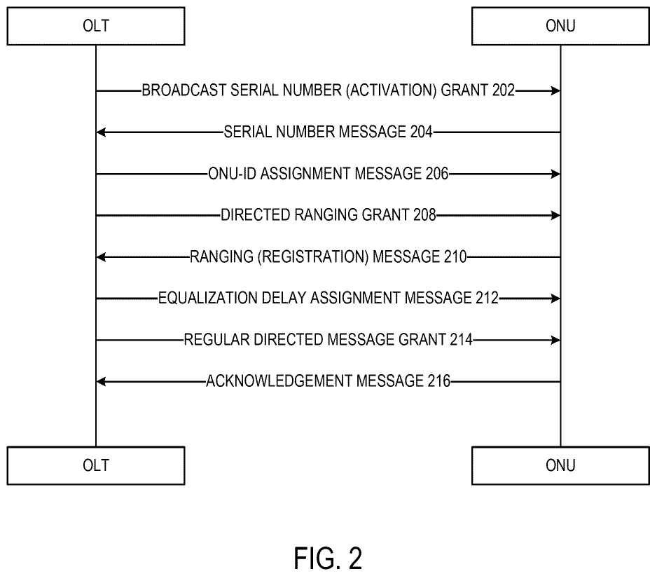

FIG. 2 is a sequence diagram illustrating an ONU activation process between an OLT and an ONU in a PON according to some of the disclosed embodiments. Whether a PON system employs a single OLT unit operating at a single wavelength channel pair and fixed-wavelength ONUs or multiple OLT units each operating at its own multiple wavelength channel pair and tunable ONUs, the ONU activation process invariably takes place between the given ONU and one OLT unit. The OLT units in a multi-wavelength-channel-pair PON systems can communicate with each other using well-known protocols and exchange relevant status, operation and maintenance information.

In general, the illustrated registration process occurs whenever an ONU attempts to join the network, whether during initial installation, after a power cycle, following a network disruption, or upon OLT's instruction to reactivate. In some implementations, the process begins when the OLT transmits a broadcast serial number grant message in step 202, where the grant message consists of a specific structure within the bandwidth map. In some implementations, this grant message occurs during a time interval (referred to as a quiet window), during which all previously activated ONUs remain silent. In some implementations, the quiet window duration is typically set to accommodate the maximum round-trip time supported by the network, usually corresponding to the maximum physical distance of, for example, twenty kilometers. When a new ONU detects this grant message, it responds with a serial number OAM message. This ensures that any response from a newly connecting ONU can be received without interference from existing network traffic.

In some implementations, the quiet window duration can be calculated to ensure reliable detection of new ONUs regardless of their physical location on the network. Since optical signals in fiber travel at approximately two-thirds the speed of light in a vacuum, a maximum fiber distance of, for example, twenty kilometers requires approximately 250 microseconds for a round-trip signal propagation. The quiet window must therefore exceed this duration to account for various system processing delays and ensure that even ONUs at the maximum supported distance can successfully respond to the serial number grant without interference from other ONU transmissions.

In response to the serial number grant, an unregistered ONU sends a serial number OAM message in step 204 containing its unique ONU serial number. In some implementations, the ONU serial number can comprise an eight-byte identifier consisting of a four-byte vendor ID and a four-byte vendor-specific serial number (VSSN). In some implementations, this message represents the ONU's first attempt to join the network and establishes its initial presence to the OLT.

Upon receiving the serial number OAM message, the OLT sends an ONU-ID assignment OAM message in step 206 to the newly detected ONU. In some implementations, the ONU-ID is a compact identifier, typically much shorter than the full serial number, that will be used for subsequent communications within the PON. This assignment message includes both the ONU's full serial number (to identify the intended recipient) and the newly assigned ONU-ID. As will be discussed, for later fingerprinting processes, this message is sent within a specific (e.g., 125-microsecond) frame identified by an SFC.

Following the ONU-ID assignment, the OLT issues a directed ranging grant in step 208 addressed to the new ONU using its assigned ONU-ID. This grant can allocate a specific time slot for the ONU to transmit a ranging message, allowing the OLT to measure the round-trip time to the ONU's location on the network.

The ONU responds with a ranging (registration) OAM message in step 210 during its allocated time slot. In some implementations, this message serves multiple purposes. First, it can allow the OLT to calculate the physical distance to the ONU based on the transmission delay. Second, it can confirm the ONU's ability to receive and respond to directed grants properly. Third, in some standardized PON systems, this message can provide additional authentication information as part of the registration process.

Based on the measured round-trip time, the OLT can send an equalization delay assignment OAM message to the ONU in step 212. This message, also sent within a specific (e.g., 125-microsecond) frame with its own SFC, can inform the ONU how much delay to add to its transmissions to ensure they arrive at the OLT at the expected time. The equalization delay can thus compensate for the different physical distances between the OLT and various ONUs in the network.

After the equalization delay is set, the OLT can send a regular directed message grant to the ONU in step 214. This grant represents the transition from the registration phase to normal operation, allowing the ONU to begin regular upstream transmission according to the established timing parameters.

Finally, the ONU can send an acknowledgment OAM message in step 216, confirming successful completion of the activation process and readiness for normal operation. At this point, the ONU is fully registered and can be ready for service configuration and provisioning.

The timing and sequence of these messages, particularly the ONU-ID assignment message (step 206) and equalization delay assignment message (step 212), can be used by the system in the fingerprinting process described in following figures. The SFCs associated with these messages can provide unique temporal markers that, optionally combined with other parameters such as the assigned ONU-ID and significant digits of equalization delay values, can create distinctive fingerprints for each registration event. These fingerprints can then be used in detecting duplicate serial numbers, as will be detailed in the description of following figures.

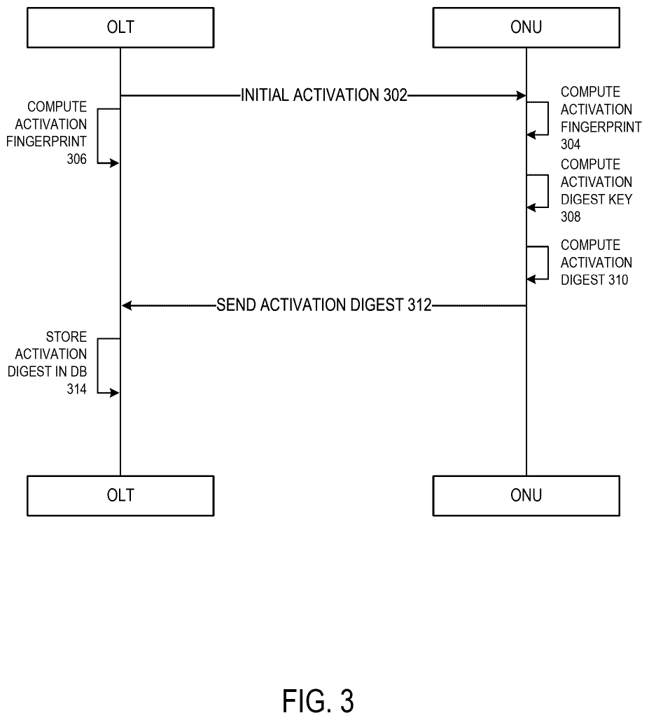

FIG. 3 is a sequence diagram illustrating a method for detecting duplicate ONU serial numbers using activation history.

In the illustrated figure, a method can implement a continuous authentication scheme based on a history of activation fingerprints and digest keys, enabling the detection of both accidental and malicious serial number duplication without relying on pre-shared secrets.

The illustrated process can begin with an initial activation 302 of an ONU. This activation can follow the standard registration process described in FIG. 2, including the transmission of serial number messages, ONU-ID assignment, ranging, and equalization delay assignment. Within this process, both the ONU and OLT independently capture activation fingerprints as described below.

In step 304, the ONU can compute its activation fingerprint based on specific temporal and operational parameters from the activation process. The fingerprint can include, but is not limited to, at least two primary components: the SFC value associated with the ONU-ID assignment message and the SFC value associated with the equalization delay assignment message. These SFC values, which may be represented as 64-bit structures that count 125-microsecond frames, can provide precise temporal markers for the activation event. In some implementations, the fingerprint may also incorporate additional parameters such as the assigned ONU-ID, the significant digits of calculated equalization delay, and other operational control structure elements.

The activation fingerprint's temporal components can be precisely measured in units of 125-microsecond frames, corresponding to the fundamental timing structure of ITU-T PON systems. In some implementations, each frame can be identified by a 64-bit SFC, which includes a 51-bit counter and a 13-bit error control field. In some implementations, the counter portion increments with each frame, creating a sequence of unique timestamps that will not repeat during the operational lifetime of the PON system. This precise temporal granularity can ensure that even ONUs activating in close succession will generate distinct fingerprints. The combination of the SFC values from the ONU-ID assignment and equalization delay assignment messages can create a unique temporal signature for each activation event, which can be further buttressed by incorporating additional parameters such as the assigned ONU-ID (which is unique within a given PON), the calculated equalization delay (which reflects the ONU's physical location), and other operational parameters from the activation sequence.

Beyond the SFC values, the activation fingerprint can optionally incorporate several additional parameters to enhance its uniqueness and security. These parameters may include: the ONU transmission wavelength characteristics measured during activation, the received power levels during ranging, the number of ranging attempts required for successful activation, the measured response times to various activation messages, and the stability metrics of the ONU's clock during ranging. The selection of additional parameters balances the need for fingerprint uniqueness against the requirement for reproducibility across legitimate reactivation attempts. Parameters with high variability across normal reactivations are weighted less significantly in the fingerprint computation or may be quantized into discrete ranges to ensure consistent fingerprint generation for legitimate devices.

Simultaneously, in step 306, the OLT can compute the same activation fingerprint using identical parameters from its perspective of the activation process. Because both the OLT and ONU observe the same activation events and timing markers, they will generate identical fingerprints for a legitimate activation sequence.

In step 308, the ONU can generate an activation digest key. In some implementations, this key is a random number generated independently by the ONU and kept private until a subsequent activation attempt. In some implementations, the digest key allows the ONU to prove knowledge of previous activation events. In some implementations, the random value used as the digest key can be software-generated (e.g., pseudo-random) or hardware-generated (e.g., using a physically unclonable function or similar technique).

Using both the activation fingerprint and the digest key, the ONU can compute an activation digest in step 310. In some implementations, this computation can employ a one-way hash function, combining the fingerprint and digest key to produce a fixed-length digest value. In some implementations, the one-way hash function exhibits several security properties: it is computationally infeasible to find any input values that would produce a given digest value (pre-image resistance), and given partial input such as the fingerprint, it is computationally infeasible to determine a digest key that would produce a specific digest value (partial pre-image resistance). These properties ensure the security of the digest even though the digest value contains less information than the original inputs.

In some implementations, the one-way hash function used for digest computation may be implemented using standard cryptographic hash algorithms such as SHA-256 or SHA-3. In some implementations, the input to the hash function can be constructed by concatenating the components in a specific order: first the activation fingerprint components (SFC values), followed by any additional parameters, and finally the digest key. To ensure consistent hashing across different implementations, the concatenation can follow a defined format where each component is allocated a fixed number of bytes, with the SFC values occupying eight bytes each, the ONU-ID using two bytes, the equalization delay using four bytes, and the digest key using 32 bytes. This structured input format ensures that different combinations of input values always produce unique hash inputs, preventing hash collisions that could compromise the system's security.

In step 312, the ONU can transmit the computed activation digest to the OLT. Importantly, at this stage, the ONU retains its digest key privately and does not share it with the OLT or any other network entity. In step 314, the OLT can store the received activation digest in its database, associating it with the ONU's serial number. This stored digest can serve as a reference point for authenticating future activation attempts by any ONU claiming the same serial number, as will be discussed.

In some implementations, the digest key at the ONU may be stored in a protected memory area, e.g., using dedicated EEPROM or Flash memory blocks with error detection and correction capabilities. To guard against memory corruption or partial failure, the digest key may be stored with redundancy, including checksums or error-correcting codes. The memory area can further be protected against unauthorized access and modification, e.g., using hardware-based security features when available. The system may also implement a mechanism to detect tampering attempts, such as monitoring for unexpected changes in stored values or attempts to access the protected memory area through unauthorized means.

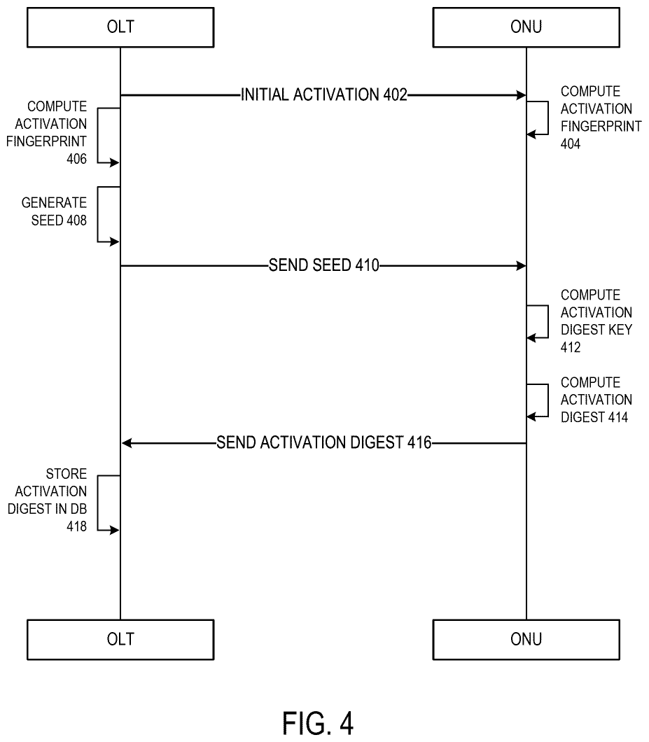

FIG. 4 is a sequence diagram illustrating an alternative method for detecting duplicate ONU serial numbers using activation history.

The illustrated embodiment extends the continuous authentication scheme described in FIG. 3 by utilizing OLT-generated seeds, which, in some implementations, can provide additional security through controlled randomization of the activation digest computation.

The process begins with an initial activation in step 402 of an ONU, following the registration process described in FIG. 2, including the transmission of serial number messages, ONU-ID assignment, ranging, and equalization delay assignment. During this process, both the ONU and OLT can independently compute activation fingerprints as described below.

In step 404, the ONU computes its activation fingerprint based on specific temporal and operational parameters from the activation process. As in FIG. 3, the fingerprint can include at least two primary components: the SFC value associated with the ONU-ID assignment message and the SFC value associated with the equalization delay assignment message. These SFC values, which may be 64-bit structures that count 125-microsecond frames, can provide precise temporal markers for the activation event. The fingerprint may also incorporate additional parameters such as the assigned ONU-ID, the calculated equalization delay, and other operational control structure elements.

In step 406, the OLT computes the same activation fingerprint using identical parameters from its perspective of the activation process. Because both the OLT and ONU observe the same activation events and timing markers, they should generate identical fingerprints for a legitimate activation sequence.

In this embodiment, the OLT takes an additional step 408 of generating a seed value. This seed can be a random number generated by the OLT that will be used to enhance the security of the activation digest computation. The OLT transmits this seed to the ONU in step 410. While the seed transmission occurs over the PON and could potentially be intercepted, its value is generally only useful in combination with other secure elements of the authentication process.

In step 412, the ONU generates an activation digest key. This key is a random number generated independently by the ONU and kept private until a subsequent activation attempt. The digest key allows the ONU to prove knowledge of previous activation events.

Using the activation fingerprint, the received seed, and the digest key, the ONU computes an activation digest in step 414. This computation can employ a one-way hash function, combining all three elements to produce a fixed-length digest value. The inclusion of the OLT-generated seed in this computation provides an additional layer of randomization, while maintaining the property that the digest cannot be reversed to derive the original inputs.

In step 416, the ONU transmits the computed activation digest to the OLT. As in the first embodiment, the ONU retains its digest key privately at this stage and does not share it with the OLT or any other network entity. The digest key's secrecy remains central to the security of this authentication method.

The OLT stores the received activation digest in its database in step 418, associating it with the ONU's serial number and the generated seed. This stored information serves as a reference point for authenticating future activation attempts by any ONU claiming the same serial number.

This seed-based embodiment maintains all the security benefits of the process of FIG. 3 while adding an additional layer of OLT-controlled randomization to the authentication process. The seed ensures that even if an attacker could observe network traffic and capture activation fingerprints, they would need both the seed and the privately held digest key to generate valid authentication digests. As with FIG. 3, the system could only potentially be defeated in cases of dynamic cloning with ultra-low-latency communication between ONUs, requiring perfect synchronization of internal states and digest keys while coordinating network access to appear as a single device.

The seed-based approach in FIG. 4 provides enhanced protection against serial number duplication while maintaining the automated nature of PON activation processes. It requires no manual configuration of security parameters and operates transparently within existing PON protocols, adding security through careful timing, state management, and controlled randomization rather than through additional protocol overhead.

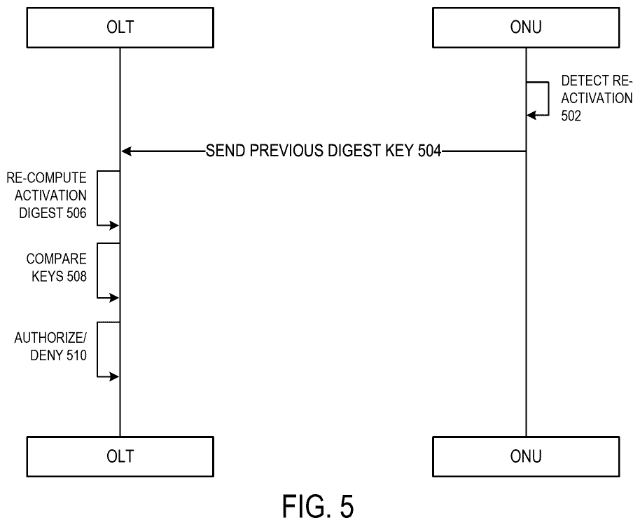

FIG. 5 is a sequence diagram illustrating a method for detecting duplicate ONU serial numbers during re-activation of an ONU according to some of the disclosed embodiments.

The following sequence of processes and interactions can be performed each time an ONU attempts to reactivate with a PON system. This reactivation sequence can occur in various situations, such as after a power loss, network disruption, or in response to an OLT instruction to reactivate. Unlike initial activation, which establishes the authentication parameters, reactivation uses previously stored values to enable rapid verification of the ONU's identity while maintaining security.

In step 502, the process begins with the same ONU used in FIG. 3 or FIG. 4 (or potentially, a different ONU claiming the same serial number) detecting an attempt to re-activate on the network. In some implementations, an ONU can detect a re-activation in various situations (e.g., power loss, etc.). As discussed in FIG. 3 and FIG. 4, prior to step 502, an ONU may have performed a single initial activation. Upon generating and storing the digest key (as discussed above), subsequent re-activations may forego fingerprinting, key generation, and digest computation. Thus, during re-activation, the ONU retrieves the previously stored digest key in step 502. In some implementations, this digest key may be stored in a secure (e.g., write-protected) region of memory of the ONU.

In step 504, the ONU sends its previous digest key to the OLT. As discussed above, this key represents the private random number generated during the ONU's last activation attempt using the process described in either FIG. 3 or FIG. 4. The re-activation process is deliberately simplified to enable rapid verification against stored values rather than requiring a completely new fingerprinting sequence.

Upon receiving the previous digest key, the OLT can perform step 506, computing an activation digest using the stored fingerprint from the previous activation and the received digest key. This computation employs the same one-way hash function used by the ONU, combining the previous fingerprint with the provided digest key.

While the digest key is transmitted over the network during this verification step, the system's security is still maintained. Specifically, any attempt to reuse a captured previous digest key would fail to authenticate future activations, as each new activation requires both the generation of a new random digest key and the capture of unique timing values that occur during that the initial activation sequence. This ensures that knowledge of a previous digest key alone is insufficient to enable unauthorized network access, as an attacker would need to maintain an unbroken chain of valid activations, each with their own unique timing characteristics and newly generated keys, to successfully impersonate a legitimate ONU.

In step 508, the OLT can compare the newly computed digest with the digest value stored in its database from the previous activation. In response, in step 510, the method can include authorizing or denying the re-activation based on the comparison in step 508. This comparison can act as the authentication mechanism of the system. A match between the computed and stored digests indicates that the activating ONU possesses knowledge of both the previous activation fingerprint and the private digest key used to compute the stored digest. This strongly suggests that the activating ONU is the same device that performed the previous activation.

Mismatches between the digests may indicate potential serial number duplication, which might occur through accidental manufacturer assignment, malicious programming of devices, static cloning without synchronization capability, or loss of non-volatile memory in legitimate devices. The strength of this authentication method lies in its dynamic nature, basing authentication on the ONU's ability to demonstrate knowledge of its own activation history rather than static pre-shared secrets or hardware identifiers that could be compromised.

This embodiment provides protection against serial number duplication while maintaining the automated nature of PON activation processes. It requires no manual configuration of security parameters and operates transparently within existing PON protocols, adding security through careful timing and state management rather than through additional protocol overhead. The activation history-based authentication approach is particularly effective against insider threats and cooperative malicious duplication. Unlike systems based on pre-shared secrets or static credentials, which can be compromised if an operator's agent is corrupted, this approach remains secure even if an attacker gains access to the OLT's current database state. This is because the authentication depends on future proof of knowledge of previously generated digest keys, which are never stored in the OLT's systems. Even if an attacker obtains a complete copy of the OLT's authentication database and the full activation history of a target ONU, they cannot predict or precompute the digest keys that will be used in future authentications.

In some embodiments, immediately after a successful re-activation (or concurrently, or prior), the ONU may initiate a new activation sequence to establish fresh security parameters (using, for example, the methods of FIG. 3 or 4). This subsequent activation generates a new fingerprint and digest key, computing a new activation digest that replaces the one used in re-activation. In some implementations, the fingerprint generated during the initial activation may be re-used while in other implementations a new fingerprint may be captured. This forward-looking security measure ensures that even if a malicious actor captures a digest key during re-activation, that key becomes immediately obsolete and cannot be used for future authentication attempts. The system maintains security by renewing its authentication parameters, requiring any potential attacker to actively participate in the full protocol sequence rather than simply replay captured credentials.

In some implementations, the methods above can include subroutines to detect false positives. For example, when an ONU undergoes a factory reset or experiences non-volatile memory failure, it loses access to its previous digest keys. To handle such cases, the system can implement a secure recovery procedure that temporarily allows activation with additional authentication factors, such as manual operator intervention or alternative authentication methods. In some implementations, the recovery process might include mandatory physical inspection of the ONU, verification of manufacturing details against secure databases, or time-limited suspension of duplicate detection with enhanced monitoring for suspicious behavior.

In some implementations, the recovery procedure can implement a graduated response based on the specific failure mode detected. When an ONU fails authentication due to missing or corrupted digest keys, the system can first verify whether this represents an isolated incident or part of a pattern. For isolated failures, the system initiates a provisional activation period, typically lasting 24 to 72 hours, during which the ONU operates under enhanced monitoring. During this period, the ONU's timing parameters, traffic patterns, and physical layer characteristics are continuously compared against historical baseline measurements. The provisional activation requires operator acknowledgment and may be limited to a reduced service level. If no suspicious behavior is detected during the provisional period, the ONU transitions to normal operation with a fresh activation history. For repeated authentication failures or suspicious behavior patterns, the system requires physical verification of the ONU. This involves comparing the device's manufacturing details, including hardware revision, firmware version, and physical serial number, against a secure database of legitimate ONUs. The verification process may also include physical inspection of optical characteristics such as wavelength stability, receiver sensitivity, and transmission power levels, as these parameters are difficult to precisely duplicate in counterfeit devices. To prevent exploitation of the recovery mechanism itself, the system implements strict rate limiting of recovery attempts (typically no more than three attempts per ONU per 24-hour period) and requires progressively more stringent verification steps for repeated failures. All recovery events are logged with detailed timing and parameter data for subsequent security analysis.

In some implementations, when a digest mismatch occurs, the OLT can determine whether the mismatch is due to legitimate non-volatile memory loss rather than a duplicate ONU attempt. In some implementations, the OLT examines the ONU's response patterns during the activation sequence, particularly looking for indicators consistent with memory reset conditions. These indicators include the ONU reporting default configuration values for various operational parameters, the presence of initialization values in management information fields, and specific patterns in the ONU's capability reporting that suggest a factory reset condition. Additionally, the OLT may verify the continuity of other device-specific parameters that would persist even through memory loss, such as calibration values and hardware identifiers stored in separate memory regions.

In some implementations, memory loss detection may also involve analyzing the timing patterns of authentication failures. A legitimate ONU experiencing memory failure will typically show a single, abrupt transition from successful authentications to failed authentications, often following power cycling or software upgrade events. In contrast, duplicate ONUs often exhibit intermittent authentication successes and failures as they attempt to alternate network access. The OLT maintains a history of authentication attempts and their timing patterns to help distinguish between these scenarios. This analysis helps prevent malicious actors from exploiting the memory loss recovery mechanism by falsely claiming memory failures.

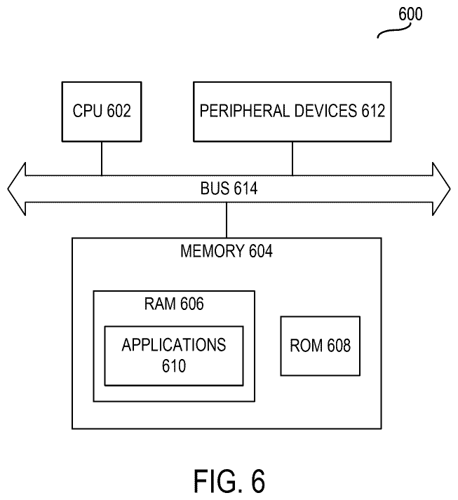

FIG. 6 is a block diagram illustrating a computing device according to some of the disclosed embodiments.

As illustrated, the device 600 includes a processor or central processing unit (CPU) such as CPU 602 in communication with a memory 604 via a bus 614. The device also includes one or more input/output (I/O) or peripheral devices 612. Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some embodiments, the CPU 602 may comprise a general-purpose CPU. The CPU 602 may comprise a single-core or multiple-core CPU. The CPU 602 may comprise a system-on-a-chip (SoC) or a similar embedded system. In some embodiments, a graphics processing unit (GPU) may be used in place of, or in combination with, a CPU 602. Memory 604 may comprise a memory system including a dynamic random-access memory (DRAM), static random-access memory (SRAM), Flash (e.g., NAND Flash), or combinations thereof. In one embodiment, the bus 614 may comprise a Peripheral Component Interconnect Express (PCIe) bus. In some embodiments, the bus 614 may comprise multiple busses instead of a single bus.

Memory 604 illustrates an example of a non-transitory computer storage media for the storage of information such as computer-readable instructions, data structures, program modules, or other data. Memory 604 can store a basic input/output system (BIOS) in read-only memory (ROM), such as ROM 608 for controlling the low-level operation of the device. The memory can also store an operating system in random-access memory (RAM) for controlling the operation of the device.

Applications 610 may include computer-executable instructions which, when executed by the device, perform any of the methods (or portions of the methods) described previously in the description of the preceding figures. In some embodiments, the software or programs implementing the method embodiments can be read from a hard disk drive (not illustrated) and temporarily stored in RAM 606 by CPU 602. CPU 602 may then read the software or data from RAM 606, process them, and store them in RAM 606 again.

The device may optionally communicate with a base station (not shown) or directly with another computing device. One or more network interfaces in peripheral devices 612 are sometimes referred to as a transceiver, transceiving device, or network interface card (NIC).

An audio interface in peripheral devices 612 produces and receives audio signals such as the sound of a human voice. For example, an audio interface may be coupled to a speaker and microphone (not shown) to enable telecommunication with others or generate an audio acknowledgment for some action. Displays in peripheral devices 612 may comprise liquid crystal display (LCD), gas plasma, light-emitting diode (LED), or any other type of display device used with a computing device. A display may also include a touch-sensitive screen arranged to receive input from an object such as a stylus or a digit from a human hand.

A keypad in peripheral devices 612 may comprise any input device arranged to receive input from a user. An illuminator in peripheral devices 612 may provide a status indication or provide light. The device can also comprise an input/output interface in peripheral devices 612 for communication with external devices, using communication technologies, such as USB, infrared, Bluetooth®, or the like. A haptic interface in peripheral devices 612 provides tactile feedback to a user of the client device.

A GPS receiver in peripheral devices 612 can determine the physical coordinates of the device on the surface of the Earth, which typically outputs a location as latitude and longitude values. A GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In one embodiment, however, the device may communicate through other components, providing other information that may be employed to determine the physical location of the device, including, for example, a media access control (MAC) address, Internet Protocol (IP) address, or the like.

The device may include more or fewer components than those shown in FIG. 6, depending on the deployment or usage of the device. For example, a server computing device, such as a rack-mounted server, may not include audio interfaces, displays, keypads, illuminators, haptic interfaces, Global Positioning System (GPS) receivers, or cameras/sensors. Some devices may include additional components not shown, such as graphics processing unit (GPU) devices, cryptographic co-processors, artificial intelligence (AI) accelerators, or other peripheral devices.

The subject matter disclosed above may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The preceding detailed description is, therefore, not intended to be taken in a limiting sense.

Throughout the specification and claims, terms may have nuanced meanings suggested or implied in context beyond an explicitly stated meaning. Likewise, the phrase “in an embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and,” “or,” or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, application-specific integrated circuit (ASIC), or other programmable data processing apparatus, such that the instructions, which execute via the processor of the computer or other programmable data processing apparatus, implement the functions/acts specified in the block diagrams or operational block or blocks. In some alternate implementations, the functions or acts noted in the blocks can occur out of the order noted in the operational illustrations. For example, two blocks shown in succession can in fact be executed substantially concurrently or the blocks can sometimes be executed in the reverse order, depending upon the functionality or acts involved.

We claim:

1. A method comprising:
receiving, at an optical line terminal (OLT), an activation request from an optical network unit (ONU) declaring a specific unique Serial Number (SN);
computing an activation fingerprint based on characteristic parameters of an ONU activation attempt captured during activation of the ONU;
receiving an activation digest computed by an activating ONU using the activation fingerprint and a privately maintained digest key;
storing the activation digest;
receiving, during a subsequent activation attempt by an ONU declaring a same unique Serial Number (SN), the digest key used to compute the stored activation digest; and
determining whether the activating ONU is the same ONU that participated in the ONU activation attempt by comparing the stored activation digest with a verification digest computed using the stored activation fingerprint and the received digest key.

2. The method of claim 1, further comprising:
generating a random seed value; and
transmitting the random seed value to the ONU before receiving the activation digest, wherein the activation digest is computed using the activation fingerprint, the digest key, and the random seed value.

3. The method of claim 1, wherein the activation fingerprint comprises one of:
a first Superframe Counter (SFC) value associated with an ONU-ID assignment message;
a second SFC value associated with an equalization delay assignment message; or
a combination of the first SFC value and the second SFC value.

4. The method of claim 1, wherein prior to sending the activation digest key to the OLT, the ONU sends a second activation digest to the OLT computed using a first seed from a previous activation attempt, a second seed from a current activation attempt, and the second activation digest key.

5. The method of claim 1, further comprising:
detecting a mismatch between the verification digest and the stored activation digest;
determining whether the mismatch is due to a loss of non-volatile memory in the ONU; and
initiating a recovery procedure if the mismatch is due to memory loss.

6. The method of claim 1, wherein computing the activation fingerprint comprises:
measuring ONU transmission wavelength characteristics during activation;
measuring received power levels during ranging;
determining a number of ranging attempts required for successful activation; and
measuring response times to activation messages.

7. The method of claim 1, wherein the ONU maintains the digest key in non-volatile memory, and determining whether the ONU is authorized comprises:
examining ONU response patterns during activation for indicators of memory reset conditions;
detecting whether the ONU reports default configuration values;
verifying presence of initialization values in management information fields; and
verifying continuity of device-specific parameters stored in separate memory regions.

8. A non-transitory computer-readable storage medium for tangibly storing computer program instructions capable of being executed by a computer processor, the computer program instructions defining steps of:
receiving, at an optical line terminal (OLT), an activation request from an optical network unit (ONU) declaring a specific unique Serial Number (SN);
computing an activation fingerprint based on characteristic parameters of an ONU activation attempt captured during activation of the ONU;
receiving an activation digest computed by an activating ONU using the activation fingerprint and a privately maintained digest key;
storing the activation digest;
receiving, during a subsequent activation attempt by an ONU declaring a same unique Serial Number (SN), the digest key used to compute the stored activation digest; and
determining whether the activating ONU is the same ONU that participated in the ONU activation attempt by comparing the stored activation digest with a verification digest computed using the stored activation fingerprint and the received digest key.

9. The non-transitory computer-readable storage medium of claim 8, the steps further comprising:
generating a random seed value; and
transmitting the random seed value to the ONU before receiving the activation digest, wherein the activation digest is computed using the activation fingerprint, the digest key, and the random seed value.

10. The non-transitory computer-readable storage medium of claim 8, wherein the activation fingerprint comprises one of:
a first Superframe Counter (SFC) value associated with an ONU-ID assignment message;
a second SFC value associated with an equalization delay assignment message; or
a combination of the first SFC value and the second SFC value.

11. The non-transitory computer-readable storage medium of claim 8, wherein prior to sending the activation digest key to the OLT, the ONU sends a second activation digest to the OLT computed using a first seed from a previous activation attempt, a second seed from a current activation attempt, and the second activation digest key.

12. The non-transitory computer-readable storage medium of claim 8, the steps further comprising:
detecting a mismatch between the verification digest and the stored activation digest;
determining whether the mismatch is due to a loss of non-volatile memory in the ONU; and
initiating a recovery procedure if the mismatch is due to memory loss.

13. The non-transitory computer-readable storage medium of claim 8, wherein computing the activation fingerprint comprises:
measuring ONU transmission wavelength characteristics during activation;
measuring received power levels during ranging;
determining a number of ranging attempts required for successful activation; and
measuring response times to activation messages.

14. The non-transitory computer-readable storage medium of claim 8, wherein the ONU maintains the digest key in non-volatile memory, and determining whether the ONU is authorized comprises:
examining ONU response patterns during activation for indicators of memory reset conditions;
detecting whether the ONU reports default configuration values;
verifying presence of initialization values in management information fields; and
verifying continuity of device-specific parameters stored in separate memory regions.

15. A device comprising:
a memory; and
a processor configured to:
receive, at an optical line terminal (OLT), an activation request from an optical network unit (ONU) declaring a specific unique Serial Number (SN);
compute an activation fingerprint based on characteristic parameters of an ONU activation attempt captured during activation of the ONU;
receive an activation digest computed by an activating ONU using the activation fingerprint and a privately maintained digest key;
store the activation digest;
receive, during a subsequent activation attempt by an ONU declaring a same unique Serial Number (SN), the digest key used to compute the stored activation digest; and
determine whether the activating ONU is the same ONU that participated in the ONU activation attempt by comparing the stored activation digest with a verification digest computed using the stored activation fingerprint and the received digest key.

16. The device of claim 15, the processor further configured to:
generate a random seed value; and
transmit the random seed value to the ONU before receiving the activation digest, wherein the activation digest is computed using the activation fingerprint, the digest key, and the random seed value.

17. The device of claim 15, wherein the activation fingerprint comprises one of:
a first Superframe Counter (SFC) value associated with an ONU-ID assignment message;
a second SFC value associated with an equalization delay assignment message; or
a combination of the first SFC value and the second SFC value.

18. The device of claim 15, wherein prior to sending the activation digest key to the OLT, the ONU sends a second activation digest to the OLT computed using a first seed from a previous activation attempt, a second seed from a current activation attempt, and the second activation digest key.

19. The device of claim 15, the processor further configured to:
detect a mismatch between the verification digest and the stored activation digest;
determine whether the mismatch is due to a loss of non-volatile memory in the ONU; and
initiate a recovery procedure if the mismatch is due to memory loss.

20. The device of claim 15, wherein computing the activation fingerprint comprises:
measuring ONU transmission wavelength characteristics during activation;
measuring received power levels during ranging;
determining a number of ranging attempts required for successful activation; and
measuring response times to activation messages.
